(19) United States
(12) Patent Application Publication
(10) Pub. No.: US 2026/0030704 A1
(43) Pub. Date: Jan. 29, 2026

(54) Artificial Intelligence Enabled Teaching Support Content Creation System and Methods

(71) Applicant: Pearson Education, Inc., Bloomington, MN (US)

(72) Inventor: Ilya Gogin, Homestead, FL (US)

(21) Appl. No.: 19/284,651

(22) Filed: Jul. 29, 2025

Related U.S. Application Data
(60) Provisional application No. 63/676,900, filed on Jul. 29, 2024.

(51) Int. Cl. G06Q 50/20

(52) U.S. Cl. CPC G06Q 50/20

(57) ABSTRACT

According to another aspect of the present disclosure, a content distribution system for presenting supplementary content based on lesson content to a supervisory user comprises a processor and memory coupled to the processor, wherein the processor is configured to receive a request corresponding to an activity and the lesson content from a supervisor device. According to another aspect of the present teachings, the content content distribution system presents the supervisory user with refinement options based on the activity and lesson content. The network receives an input responsive to the refinement options and generates, using an AI model, supplementary content based at least in part on the lesson content. The supplementary content is displayed to the user, for example on a graphical user interface.

### CROSS-REFERENCE TO RELATED APPLICATIONS

This application claims the benefit of U.S. Provisional Application No. 63/676,900, filed on Jul. 29, 2024, the entire disclosure of which is incorporated herein by reference.

### BRIEF SUMMARY

According to one aspect of the present disclosure, a method for creating and presenting lessons, content, and activities based on courseware is described.

According to another aspect of the present disclosure, a content distribution system for presenting supplementary content based on lesson content to a supervisory user comprises a processor and memory coupled to the processor, wherein the processor is configured to receive a request corresponding to an activity and the lesson content from a supervisor device. According to another aspect of the present teachings, the content content distribution network presents the supervisory user with refinement options based on the activity and lesson content. The network receives an input responsive to the refinement options and generates, using an AI model, supplementary content based at least in part on the lesson content. The supplementary content is displayed to the user, for example on a graphical user interface.

### BRIEF DESCRIPTION OF THE SEVERAL VIEWS OF THE DRAWINGS

FIG. 1 illustrates a system for distributing educational content 100 in accordance with the present teachings.

FIG. 2 illustrates a system for distributing educational content 200 in accordance with one aspect of the present teachings.

FIG. 3 illustrates a method of distributing educational content in accordance with one aspect of the present teachings.

FIG. 4A illustrates an aspect of the subject matter in accordance with one aspect of the present teachings.

FIG. 4B illustrates an aspect of the subject matter in accordance with one aspect of the present teachings.

FIG. 5A illustrates graphical user interface 502 in accordance with one aspect of the present teachings.

FIG. 5B illustrates graphical user interface 502 in accordance with one aspect of the present teachings.

FIG. 5C illustrates graphical user interface 502 in accordance with one aspect of the present teachings.

FIG. 5D illustrates graphical user interface 502 in accordance with one aspect of the present teachings.

FIG. 5E illustrates graphical user interface 502 in accordance with one aspect of the present teachings.

FIG. 5F illustrates graphical user interface 502 in accordance with one aspect of the present teachings.

FIG. 5G illustrates graphical user interface 502 in accordance with one aspect of the present teachings.

FIG. 6 illustrates a routine 600 for operating a content distribution system in accordance with one aspect of the present teachings.

### DETAILED DESCRIPTION

The described systems, methods, and technologies will now be discussed in detail with regard to the attached figures briefly described above. In the present description, numerous specific details are set forth illustrating the Applicant's best mode for practicing, and enabling one of ordinary skill in the art to make and use the subject matter disclosed herein. It will be obvious, however, to one skilled in the art that the present subject matter may be practiced without many of these specific details. In other instances, well-known machines, structures, and method steps have not been described in particular detail in order to avoid unnecessarily obscuring the present. Unless otherwise indicated, like parts and method steps are referred to with like reference numerals.

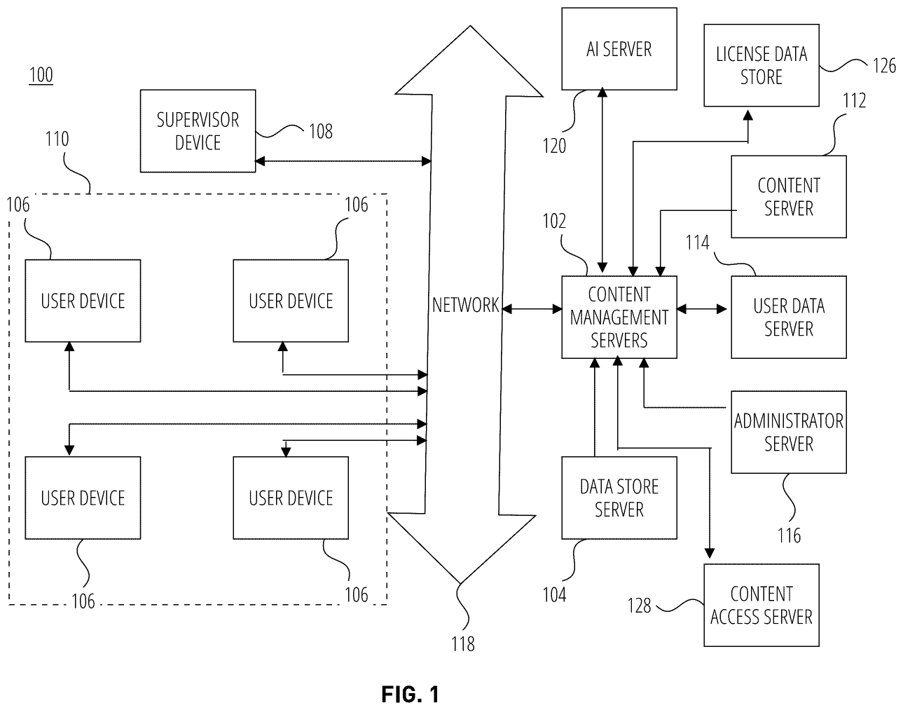

With reference now to FIG. 1, a block diagram is shown illustrating various components of a system for distributing educational content 100 (CDN) that implements and supports certain aspects and features described herein. In some aspects, the system for distributing educational content 100 can comprise one or several physical components and/or one or several virtual components such as, for example, one or several cloud computing components. In some aspects, the system for distributing educational content 100 can comprise a mixture of physical and cloud computing components.

system for distributing educational content 100 include one or more content management servers 102. As discussed below in more detail, content management servers 102 be any desired type of server including, for example, a rack server, a tower server, a miniature server, a blade server, a mini rack server, a mobile server, an ultra-dense server, a super server, or the like, and may include various hardware components, for example, a motherboard, a processing unit, memory systems, hard drives, network interfaces, power supplies, etc. Content management servers 102 include one or more server farms, clusters, or any other appropriate arrangement and/or combination of computer servers. Content management servers 102 act according to stored instructions located in a memory subsystem of the server 102, and may run an operating system, including any commercially available server operating system and/or any other operating systems discussed herein.

The content distribution system 100 include one or more data store servers 104, such as database servers and file-based storage systems. The data store servers 104 can access data that can be stored on a variety of hardware components. These hardware components can include, for example, components forming tier 0 storage, components forming tier 1 storage, components forming tier 2 storage, and/or any other tier of storage. In some embodiments, tier 0 storage refers to storage that is the fastest tier of storage in the data store servers 104, and particularly, the tier 0 storage is the fastest storage that is not RAM or cache memory. In some embodiments, the tier 0 memory can be embodied in solid state memory such as, for example, a solid-state drive (SSD) and/or flash memory.

In some aspects, the tier 1 storage refers to storage that is one or several higher performing systems in the memory management system, and that is relatively slower than tier 0 memory, and relatively faster than other tiers of memory. The tier 1 memory can be one or several hard disks that can be, for example, high-performance hard disks. These hard disks can be one or both of physically or communicatively connected such as, for example, by one or several fiber channels. In some embodiments, the one or several disks can be arranged into a disk storage system, and specifically can be arranged into an enterprise class disk storage system. The disk storage system can include any desired level of redundancy to protect data stored therein, and in one embodiment, the disk storage system can be made with grid architecture that creates parallelism for uniform allocation of system resources and balanced data distribution.

In some aspects, the tier 2 storage refers to storage that includes one or several relatively lower performing systems in the memory management system, as compared to the tier 1 and tier 2 storages. Thus, tier 2 memory is relatively slower than tier 1 and tier 0 memories. Tier 2 memory can include one or several SATA-drives or one or several NL-SATA drives.

In some aspects, the one or several hardware and/or software components of the database 104 (also referred to as data stores) can be arranged into one or several storage area networks (SAN), which one or several storage area networks can be one or several dedicated networks that provide access to data storage, and particularly that provide access to consolidated, block level data storage. A SAN typically has its own network of storage devices that are generally not accessible through the local area network (LAN) by other devices. The SAN allows access to these devices in a manner such that these devices appear to be locally attached to the user device.

Data store servers 104 may comprise stored data relevant to the functions of the system for distributing educational content 100. In some aspects, multiple data stores may reside on a single data store server 104, either using the same storage components of data store server 104 using different physical storage components to assure data security and integrity between data stores. In other aspects, each data store may have a separate dedicated data store server 104.

A system for distributing educational content 100 also may include one or more user devices 106 and/or supervisor devices 108. User devices 106 and supervisor devices 108 may display content received via the system for distributing educational content 100, and may support various types of user interactions with the content. User devices 106 and supervisor devices 108 may include mobile devices such as smartphones, tablet computers, personal digital assistants, and wearable computing devices. Such mobile devices may run a variety of mobile operating systems, and may be enabled for Internet, e-mail, short message service (SMS), Bluetooth®, mobile radio-frequency identification (M-RFID), near-field communication (NFC), and/or other communication protocols. Other user devices 106 and supervisor devices 108 may be general purpose personal computers or special-purpose computing devices including, by way of example, personal computers, laptop computers, workstation computers, projection devices, and interactive room display systems. Additionally, user devices 106 and supervisor device 108 may be any other electronic devices, such as thin-client computers, Internet-enabled gaming systems, business or home appliances, and/or personal messaging devices, capable of communicating over network(s) such as network 118.

In different contexts of systems for distributing educational content 100, user devices 106 and supervisor devices 108 may correspond to different types of specialized devices, for example, student devices and teacher devices in an educational network, employee devices and presentation devices in a company network, different gaming devices in a gaming network, etc. In some embodiments, user devices 106 and supervisor devices 108 may operate in the same physical location 110, such as a classroom or conference room. In such cases, the devices may contain components that support direct communications with other nearby devices, such as a wireless transceivers and wireless communications interfaces, Ethernet sockets or other Local Area Network (LAN) interfaces, etc. In other implementations, the user devices 106 and supervisor devices 108 need not be used at the same physical location 110, but may be used in remote geographic locations in which each user device 106 and supervisor device 108 may use security features and/or specialized hardware (e.g., hardware-accelerated Secure Socket Layer (SSL) and Secure Hypertext Transfer Protocol (HTTPS), WS-Security, firewalls, etc.) to communicate with the content management servers 102. Additionally, different user devices 106 and supervisor devices 108 may be assigned different designated roles, such as presenter devices, teacher devices, administrator devices, or the like, and in such cases the different devices may be provided with additional hardware and/or software components to provide content and support user capabilities not available to the other devices.

As illustrated in FIG. 1, the content management servers 102 can be in communication with one or more additional servers, such as a content server 112, a user data server 114, or an administrator server 116. Each of these servers may include some or all of the same physical and logical components as the content management servers 102, and in some cases, the hardware and software components of these servers may be incorporated into the content management servers 102, rather than being implemented as separate computer servers.

content server 112 may include hardware and software components to generate, store, and maintain, and coordinate the content resources for distribution to user devices 106 and other devices in the system for distributing educational content 100. For example, in systems for distributing educational content 100 used for professional training and educational purposes, content server 112 may include data stores of textbooks, teacher's manuals, student manuals, laboratory manuals, supplementary materials, training materials, presentations, plans, syllabi, reviews, evaluations, interactive programs and simulations, course models, course outlines, and various training interfaces that correspond to different materials and/or different types of user devices 106.

User data server 114 may include hardware and software components that store and process data for multiple users relating to each user's activities and usage of the system for distributing educational content 100. For example, the content management servers 102 may record and track each user's system usage, including his or her user device 106, and content resources accessed. This data may be stored and processed by the user data server 114, to support user tracking and analysis features. For instance, in the professional training and educational contexts, the user data server 114 may store and analyze each user's training materials viewed, presentations attended, courses completed, interactions, evaluation results, and the like. The user data server 114 may also include a repository for user-generated material, such as evaluations and tests completed by users, and documents and assignments prepared by users. In the context of media distribution and interactive gaming, the user data server 114 may store and process resource access data for multiple users (e.g., content titles accessed, access times, data usage amounts, gaming histories, user devices 106 and device types, etc.). User data server 114 may contain data associated with supervisory users and standard users . . . .

Administrator server 116 may include hardware and software components to initiate various administrative functions at the content management servers 102 and other components within the system for distributing educational content 100. For example, the administrator server content server 112 may monitor device status and performance for the various servers, data stores, and/or user devices 102 in the system for distributing educational content 100. When necessary, the administrator server 116 may add or remove devices from the system for distributing educational content 100, and perform device maintenance such as providing software updates to the devices in the system for distributing educational content 100. Various administrative tools on the administrator server 116 allow authorized users to set user access permissions to various content resources, monitor resource usage by users and user devices 106, and perform analyses and generate reports on specific network users and/or devices (e.g., resource usage tracking reports, training evaluations, etc.). In one aspect of the present disclosure, the administrator server 116 can perform one or more tasks related to provided supervisory users certification of their accomplishments relating to creating and delivering lesson content as described herein. Moreover, the administrator server 116 can issue mapping between lesson content delivered to users and various educational benchmarks and standards.

The system for distributing educational content 100 may include one or more communication networks. Although only a single network 118 identified in FIG. 1, the system for distributing educational content 100 include any number of different communication networks 118 between any of the computer servers and devices shown in FIG. 1 and/or other devices described herein. Communication networks 118 enable communication between the various computing devices, servers, and other components of the system for distributing educational content 100. As discussed below, various implementations of systems for distributing educational content 100 employ different types of networks 118 for example, computer networks, telecommunications networks, wireless networks, and/or any combination of these and/or other networks.

The system for distributing educational content 100 may include one or artificial intelligence agents 120, also referred to herein as an AI Server 120, intelligence agent 120, and IA agent 120. The AI Server 120 can be an autonomous entity that can receive inputs via one or several sensors or from one or several user devices 106 or supervisor devices 108 and can provide responses to those received inputs to user devices 106 or supervisor devices 108. In some embodiments, the functioning of the AI agent 124 can be based upon upon artificial intelligence, generative artificial intelligence, machine learning, large language models (LLMs), or the like. The AI Server 120 can reside in the content management servers 102 and/or another component of the system for distributing educational content 100, or can reside on a separate server or on separate computing resources. The AI Server 120 can be configured to receive inputs from the user device 106, or supervisor device 108.

Data store servers 104 can include one of more or more individual data stores and can reside in storage on a single computer server 102 (or a single server farm or cluster) under the control of a single entity, or may reside on separate servers operated by different entities and/or at remote locations. In some embodiments, data stores may be accessed by the content management content management servers 102 and/or other devices and servers within the network 118 (e.g., user devices 106, supervisor devices 108, administrator servers 116, etc.). Access to one or more of the data stores can be limited or denied based on the processes, user credentials, and/or devices attempting to interact with the data store.

The paragraphs below describe examples of specific data stores that may be implemented within some embodiments of a system for distributing educational content 100. It should be understood that the below descriptions of data stores, including their functionality and types of data stored therein, are illustrative and non-limiting. Data stores server architecture, design, and the execution of specific data stores may depend on the context, size, and functional requirements of a system for distributing educational content 100. For example, in system for distributing educational content 100 used for professional training and educational purposes, separate databases or file-based storage systems may be implemented in data store server 104 to store trainee and/or student data, trainer and/or professor data, training module data and content descriptions, training results, evaluation data, and the like.

A data store server 104 can also include user profile data stores, also referred to herein as a user profile database, may include information relating to the end users within the system for distributing educational content 100. This information may include user characteristics such as the user names, access credentials (e.g., logins and passwords), user preferences, and information relating to any previous user interactions within the system for distributing educational content 100 (e.g., requested content, posted content, content modules completed, training scores or evaluations, other associated users, etc.). In some aspects, this information can relate to one or several individual end users such as, for example, one or several students, teachers, administrators, or the like, and in some aspects, this information can relate to one or several institutional end users such as, for example, one or several schools, groups of schools such as one or several school districts, one or several colleges, one or several universities, one or several training providers, or the like. In some aspects, this information can identify one or several user memberships in one or several groups such as, for example, a student's membership in a university, school, program, grade, course, class, or the like. The user profile database can include information relating to a user's status, location, or the like. This information can identify, for example, a user device 106 device a user is using, the location of that device 106, or the like. The system for distributing educational content 100 can also store content uploaded by certain users, such as supervisory users who upload or otherwise import courseware to use in generating lesson content.

Information relating to the user's status can identify, for example, logged-in status information that can indicate whether the user is presently logged-in to the system for distributing educational content 100 and/or whether the log-in-is active. In some aspects, the information relating to the user's status can identify whether the user is currently accessing content and/or participating in an activity from the system for distributing educational content 100

In some aspects, information relating to the user's status can identify, for example, one or several attributes of the user's interaction with the system for distributing educational content 100, and/or content distributed by the system for distributing educational content 100. This can include data identifying the user's interactions with the system for distributing educational content 100, the content or features accessed or consumed by the user through the system for distributing educational content 100, or the like. In some aspects, this can include data identifying the type of activities selected by the user to be generated through the system for distributing educational content 100 and/or the type of activity performed by the user via the system for distributing educational content 100, the lapsed time since the last time the user accessed content and/or generated an activity from the system for distributing educational content 100, or the like.

In some aspects in which the one or several end users are individuals, and specifically are students, the user data server 114 can further include information relating to these students' academic and/or educational history. This information can identify one or several courses of study that the student has initiated, completed, and/or partially completed, as well as grades received in those courses of study. In some embodiments, the student's academic and/or educational history can further include information identifying student performance on one or several tests, quizzes, and/or assignments. In some aspects, this information can be stored in a tier of memory that is not the fastest memory in the system for distributing educational content 100.

The user data store server 104 can include information relating to one or several student learning preferences. In some embodiments, for example, the user, also referred to herein as the student or the student-user may have one or several preferred learning styles, one or several most effective learning styles, and/or the like. In some aspects, the student's learning style can be any learning style describing how the student best learns or how the student prefers to learn. In one aspect, these learning styles can include, for example, identification of the student as an auditory learner, as a visual learner, and/or as a tactile learner. In some aspects, the data identifying one or several student learning styles can include data identifying a learning style based on the student's educational history such as, for example, identifying a student as an auditory learner when the student has received significantly higher grades and/or scores on assignments and/or in courses favorable to auditory learners. In some aspects, this information can be stored in a tier of memory that is not the fastest memory in the content delivery network 100.

In some aspects, the user data server 114 can further include information identifying one or several user skill levels. In some aspects, these one or several user skill levels can identify a skill level determined based on past performance by the user interacting with the content delivery network 100, and in some aspects, these one or several user skill levels can identify a predicted skill level determined based on past performance by the user interacting with the content delivery network 100 and one or several predictive models.

The user data server 114 can further include information relating to one or several teachers and/or instructors or other supervisory users who are responsible for organizing, presenting, and/or managing the presentation of information to the student. In some aspects, user data server 114 can include information identifying courses and/or subjects that have been taught by the teacher, information identifying which course content, including textbooks and related contents, to which the teach has been granted a license to use, data identifying courses and/or subjects currently taught by the teacher, and/or data identifying courses and/or subjects that will be taught by the teacher. In some aspects, this can include information relating to one or several teaching styles of one or several teachers. In some aspects, the user data server 114 can further include information indicating past evaluations and/or evaluation reports received by the teacher. In some aspects, the user data server 114 can further include information relating to improvement suggestions received by the teacher, training received by the teacher, continuing education received by the teacher, and/or the like. In some aspects, this information can be stored in a tier of memory that is not the fastest memory in the content delivery network 100.

An accounts data store, also referred to herein as an accounts database, may generate and store account data for different users in various roles within the system for distributing educational content 100. For example, accounts may be created in an accounts data store for individual end users, supervisors, administrator users, and entities such as companies or educational institutions. Account data may include account types, current account status, account characteristics, and any parameters, limits, restrictions associated with the accounts.

A content library data store, also referred to herein as a content library database, may include information describing the individual content items (or content resources or data packets) available via the system for distributing educational content 100. In some aspects, these data packets in the content library database can be linked to form an object network. In some aspects, these data packets can be linked in the object network according to one or several sequential relationship which can be, in some aspects, prerequisite relationships that can, for example, identify the relative hierarchy and/or difficulty of the data objects. In some aspects, this hierarchy of data objects can be generated by the system for distributing educational content 100 according to user experience with the object network, and in some aspects, this hierarchy of data objects can be generated based on one or several existing and/or external hierarchies such as, for example, a syllabus, a table of contents, or the like. In some aspects, for example, the object network can correspond to a syllabus such that content for the syllabus is embodied in the object network.

In some aspects, the content library database may include metadata, properties, and other characteristics associated with the content resources stored in the content server 112. Such data may identify one or more aspects or content attributes of the associated content resources, for example, subject matter, access level, or skill level of the content resources, license attributes of the content resources (e.g., any limitations and/or restrictions on the licensable use and/or distribution of the content resource), price attributes of the content resources (e.g., a price and/or price structure for determining a payment amount for use or distribution of the content resource), rating attributes for the content resources (e.g., data indicating the evaluation or effectiveness of the content resource), and the like. In some aspects, the library data store may be configured to allow updating of content metadata or properties, and to allow the addition and/or removal of information relating to the content resources. For example, content relationships may be implemented as graph structures, which may be stored in the content library data store or in an additional store for use by selection algorithms along with the other metadata.

A license data store include information relating to licenses and/or licensing of the content resources within the system for distributing educational content 100. For example, the license data store can identify licenses and licensing terms for individual content resources and/or compilations of content resources in the content server 112, the rights holders for the content resources, and/or common or large-scale right holder information such as contact information for rights holders of content not included in the content server 112.

A content access data store may include access rights and security information for the system for distributing educational content 100 and specific content resources. For example, the content access data store may include login information (e.g., user identifiers, logins, passwords, etc.) that can be verified during user login attempts to the network 100. The content access data store also may be used to store assigned user roles and/or user levels of access. For example, a user's access level may correspond to the sets of content resources and/or the client or server applications that the user is permitted to access. Certain users may be permitted or denied access to certain applications and resources based on their subscription level, training program, course/grade level, etc. Certain users may have supervisory access over one or more end users, allowing the supervisor to access all or portions of the end user's content, activities, evaluations, etc. Additionally, certain users may have administrative access over some users and/or some applications in the content management network 100, allowing such users to add and remove user accounts, modify user access permissions, perform maintenance updates on software and servers, etc.

In some aspects, these models can include a plurality of model functions including, for example, a first model function, a second model function, a third model function, and a fourth model function. In some aspects, some or all of the model functions can be associated with a portion of the program such as, for example, a completion stage and/or completion status of the program. In one aspect, for example, the first model function can be associated with a first completion status, the second model function can be associated with a second completion status, the third model function can be associated with a third completion status, and the fourth model function can be associated with a fourth completion status. In some aspects, these completion statuses can be selected such that some or all of these completion statuses are less than the desired level of completion of the program. Specifically, in some aspects, these completion statuses can be selected to all be at less than 60% completion of the program, and more specifically, in some aspects, the first completion status can be at 20% completion of the program, the second completion status can be at 30% completion of the program, the third completion status can be at 40% completion of the program, and the fourth completion status can be at 50% completion of the program. Similarly, any desired number of model functions can be associated with any desired number of completion statuses.

In some aspects, a model function can be selected from the plurality of model functions based on a student-user's progress through a program. In some aspects, the student-user's progress can be compared to one or several status trigger thresholds, each of which status trigger thresholds can be associated with one or more of the model functions. If one of the status triggers is triggered by the student-user's progress, the corresponding one or several model functions can be selected.

The model functions can comprise a variety of types of models and/or functions. In some aspects, each of the model functions outputs a function value that can be used in calculating a risk probability. This function value can be calculated by performing one or several mathematical operations on one or several values indicative of one or several user attributes and/or user parameters, also referred to herein as program status parameters. In some aspects, each of the model functions can use the same program status parameters, and in some aspects, the model functions can use different program status parameters. In some aspects, the model functions use different program status parameters when at least one of the model functions uses at least one program status parameter that is not used by others of the model functions.

In some aspects, a skill model can comprise a statistical model identifying a predictive skill level of one or several students. In some aspects, this model can identify a single skill level of a student and/or a range of possible skill levels of a student. In some aspects, this statistical model can identify a skill level of a student-user and an error value or error range associated with that skill level. In some aspects, the error value can be associated with a confidence interval determined based on a confidence level. Thus, in some aspects, as the number of student interactions with the system for distributing educational content 100 increases, the confidence level can increase and the error value can decrease such that the range identified by the error value about the predicted skill level is smaller.

The computing systems (e.g., one or more computers and servers described herein) can correspond to any one or more of the computing devices or servers of the distribution computing environment, or any other computing devices described herein. In an example, the computing systems may represent an example of one or more servers and/or of one or more servers of the distribution computing environment. In another example, the computing system may represent an example of the client computing devices of the distribution computing environment. In some examples, the computing system may represent a combination of one or more computing devices and/or servers of the distribution computing environment.

In some examples, the computing systems may include processing circuitry, such as one or more processing unit(s), processor(s), etc. In some examples, the processing circuitry may communicate (e.g., interface) with a number of peripheral subsystems via a bus subsystem. These peripheral subsystems may include, for example, a storage subsystem, an input/output (I/O) subsystem, and a communications subsystem. In some examples, the computing system can include processing circuitry, such as one or more processing units, processors, etc. In some examples, the processing circuitry may communicate (e.g., interface) with a number of peripheral subsystems via a bus subsystem. These peripheral subsystems may include, for example, a storage subsystem, an input/output (I/O) subsystem, and a communications subsystem.

In some examples, the bus subsystem provides a mechanism for intended communication between the various components and subsystems of computing system. Although the bus subsystem can be a single bus, alternative embodiments of the bus subsystem may utilize multiple buses. In some examples, the bus subsystem may include a memory bus, memory controller, peripheral bus, and/or local bus using any of a variety of bus architectures (e.g., Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

In some examples, the I/O subsystem may include one or more device controller(s) for one or more user interface input devices and/or user interface output devices, possibly integrated with the computing system (e.g., integrated audio/video systems, and/or touchscreen displays), or may be separate peripheral devices which are attachable/detachable from the computing system. Input may include keyboard or mouse input, audio input (e.g., spoken commands), motion sensing, gesture recognition (e.g., eye gestures), etc. As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like. In general, use of the term “output device” is intended to include all possible types of devices and mechanisms for outputting information from computing system, such as to a user (e.g., via a display device) or any other computing system, such as a second computing system. In an example, output devices may include one or more display subsystems and/or display devices that visually convey text, graphics and audio/video information (e.g., cathode ray tube (CRT) displays, flat-panel devices, liquid crystal display (LCD) or plasma display devices, organic light emitting display (OLED) devices, projection devices, touch screens, etc.), and/or may include one or more non-visual display subsystems and/or non-visual display devices, such as audio output devices, etc. As non-limiting examples, output devices may include, indicator lights, monitors, printers, speakers, headphones, automotive navigation systems, plotters, voice output devices, modems, etc.

In some examples, the computing system may include one or more storage subsystems, including hardware and software components used for storing data and program instructions, such as system memory and computer-readable storage media. In some examples, the system memory and/or the computer-readable storage media may store and/or include program instructions that are loadable and executable on the processor(s). In an example, the system memory may load and/or execute an operating system, program data, server applications, application program(s) (e.g., client applications), Internet browsers, mid-tier applications, etc. In some examples, the system memory may further store data generated during execution of these instructions.

In some examples, the system memory may be stored in volatile memory (e.g., random-access memory (RAM), including static random-access memory (SRAM) or dynamic random-access memory (DRAM)). In an example, the RAM may contain data and/or program modules that are immediately accessible to and/or operated and executed by the processing circuitry. In some examples, the system memory may also be stored in non-volatile storage drives (e.g., read-only memory (ROM), flash memory, etc.). In an example, a basic input/output system (BIOS), containing the basic routines that help to transfer information between elements within the computing system (e.g., during start-up), may typically be stored in the non-volatile storage drives.

In some examples, the storage subsystem may include one or more tangible computer-readable storage media for storing the basic programming and data constructs that provide the functionality of some embodiments. In an example, the storage subsystem may include software, programs, code modules, instructions, etc., that may be executed by the processing circuitry, in order to provide the functionality described herein. In some examples, data generated from the executed software, programs, code, modules, or instructions may be stored within a data storage repository within the storage subsystem. In some examples, the storage subsystem may also include a computer-readable storage media reader connected to the computer-readable storage media.

In some examples, the computer-readable storage media may contain program code, or portions of program code. Together and, optionally, in combination with the system memory, the computer-readable storage media may comprehensively represent remote, local, fixed, and/or removable storage devices plus storage media for temporarily and/or more permanently containing, storing, transmitting, and/or retrieving computer-readable information. In some examples, the computer-readable storage media may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer-readable media. This can also include nontangible computer-readable media, such as data signals, data transmissions, or any other medium which can be used to transmit the desired information and which can be accessed by the computing system. In an illustrative and non-limiting example, the computer-readable storage media may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media.

In some examples, the computer-readable storage media may include, but is not limited to, Zip® drives, flash memory cards, universal serial bus (USB) flash drives, secure digital (SD) cards, DVD disks, digital video tape, and the like. In some examples, the computer-readable storage media may include, solid-state drives (SSD) based on non-volatile memory such as flash-memory based SSDs, enterprise flash drives, solid state ROM, and the like, SSDs based on volatile memory such as solid-state RAM, dynamic RAM, static RAM, DRAM-based SSDs, magneto-resistive RAM (MRAM) SSDs, and hybrid SSDs that use a combination of DRAM and flash memory-based SSDs. The disk drives and their associated computer-readable media may provide non-volatile storage of computer-readable instructions, data structures, program modules, and other data for the computing system.

In some examples, the communications subsystem may provide a communication interface from the computing system and external computing devices via one or more communication networks, LANs, WANs (e.g., the Internet), and various wireless telecommunications networks. The communications may include, for example, one or more network interface controllers (NICs), such as Ethernet cards, Asynchronous Transfer Mode NICs, Token Ring NICs, and the like, as well as one or more wireless communications interfaces, such as wireless network interface controllers (WNICs), wireless network adapters, and the like. Additionally, and/or alternatively, the communications subsystem may include one or more modems (telephone, satellite, cable, ISDN), synchronous or asynchronous digital subscriber line (DSL) units, Fire Wire® interfaces, USB® interfaces, and the like. Communications subsystem also may include radio frequency (RF) transceiver components for accessing wireless voice and/or data networks (e.g., using cellular telephone technology, advanced data network technology, such as 3G, 4G, 5G or EDGE (enhanced data rates for global evolution), Wi-Fi (IEEE 802.11 family standards, or other mobile communication technologies, or any combination thereof), global positioning system (GPS) receiver components, and/or other components.

In some examples, the communications subsystem may also receive input communication in the form of structured and/or unstructured data feeds, event streams, event updates, and the like, on behalf of one or more users who may use or access the computing system. In an example, the communications subsystem may be configured to receive data feeds in real-time from users of social networks and/or other communication services, web feeds such as Rich Site Summary (RSS) feeds, and/or real-time updates from one or more third party information sources (e.g., data aggregators). Additionally, the communications subsystem may be configured to receive data in the form of continuous data streams, which may include event streams of real-time events and/or event updates (e.g., sensor data applications, financial tickers, network performance measuring tools, clickstream analysis tools, automobile traffic monitoring, etc.). In some examples, the communications subsystem may output such structured and/or unstructured data feeds, event streams, event updates, and the like to one or more data stores that may be in communication with one or more streaming data source computing systems (e.g., one or more data source computers, etc.) coupled to the computing system. The various physical components of the communications subsystem may be detachable components coupled to the computing system via a computer network (e.g., a communication network), a FireWire® bus, or the like, and/or may be physically integrated onto a motherboard of the computing system. In some examples, the communications subsystem may be implemented in whole or in part by software.

Due to the ever-changing nature of computers and networks, the description of the computing system depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

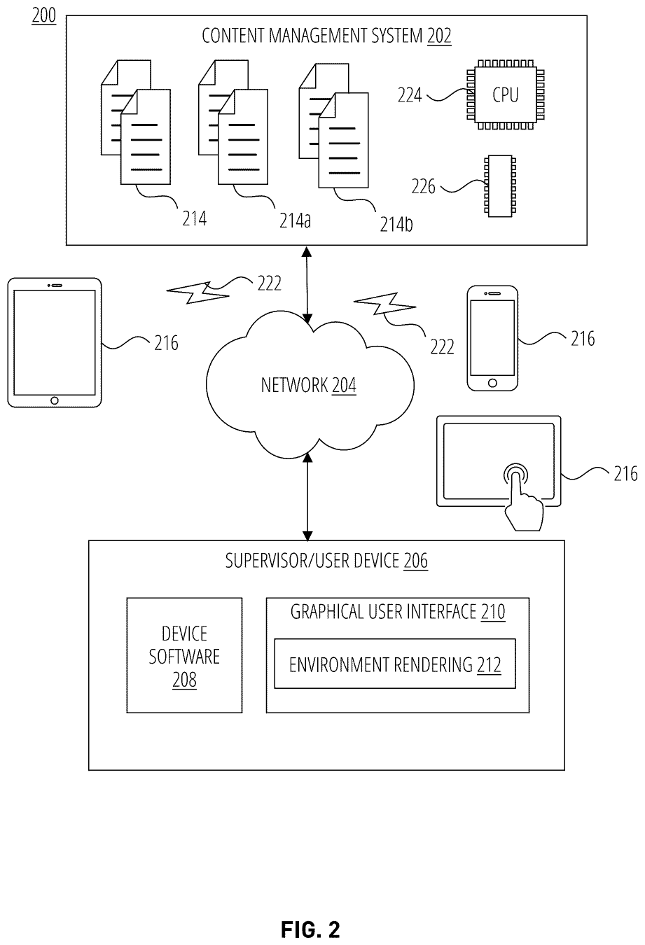

FIG. 2 illustrates a system level block diagram of a system for distributing educational content 200. The content management system 202 can include one or more databases, such as those depicted in FIG. 1, and are also referred to as data stores herein. The content management system 202 can also include processor 224 and memory 226 that can store and execute commands to be performed by the content management system 202. The databases may include a plurality of user data (e.g., a set of user data items). In such examples, the content management system 202 may store and/or manage the user data in accordance with one or more of the various techniques of the disclosure. In some examples, the user data may include user responses, user history, user scores, user performance, user preferences, and the like. In some examples, the 202 may collect and aggregate some or all user data points from various sources (e.g., platforms, a learner response assessment component, a personalization component, a personalization component, a practice generation component, etc.) to determine characteristics regarding the user. The characteristics regarding the user may be stored in the databases. In further examples, the characteristics regarding the user may be received by other sources (e.g., third-party components). Databases may further store user data about each of one or more learners, possibly enrolled in a class or an organization, and stored as a learner profile for each of the learners. In some embodiments, this data, at a high level, may derive data from a high level for a plurality dimensions and characteristics associated with each of the learners.

The content management system 202 can include courseware 214. includes receiving at the content management system 202 one of a selection of one or more pre-loaded courseware or an import of one or more courseware by the supervisory user. Courseware 214 can take many forms, in addition to e-books, several other forms of content and information can serve as courseware 214. For example, modern education leverages a diverse array of digital resources to enhance learning experiences across disciplines. Lecture recordings and webinars are foundational tools for asynchronous learning, allowing students to revisit university lectures, guest speaker sessions, and online seminars at their own pace. Peer-reviewed articles and journals, accessible through academic databases like JSTOR, PubMed, and Google Scholar, provide rigorously vetted research essential for scholarly work, suitable for courseware 214. Podcasts and audiobooks, particularly in the context of language learning, history, and science education, offering flexible, on-the-go learning opportunities. To simplify complex topics, educators often turn to infographics and visual aids, such as charts and diagrams, which make abstract concepts more digestible. In STEM fields, interactive simulations and virtual labs provide hands-on experimentation in a digital environment, fostering deeper understanding through active engagement. Similarly, games and gamified learning platforms use game mechanics to boost motivation and retention. The rise of social media and microlearning has introduced short-form educational content on platforms like YouTube, TikTok, and Instagram, particularly appealing to younger audiences. To connect learning with real-world contexts, news articles and current events are frequently used in subjects like civics, history, and language arts. Collaborative tools such as blogs, wikis, and discussion forums support peer-to-peer learning and knowledge sharing, encouraging active participation and community building. Finally, augmented reality (AR) and virtual reality (VR) are transforming education in fields like medicine, architecture, and history by offering immersive, experiential learning environments that bring abstract or distant concepts to life.

According to one aspect of the present teachings, a supervising user may import courseware 214, and specifically imported courseware 214b. A supervising user can import such imported courseware 214b in a variety of ways, including uploading documents, providing hyperlinks to publicly available information, or by entering information manually. It will be appreciated that multiple potential routes are available for importing information such as courseware 214. Once uploaded, the courseware 214 can be processed using, for example, AI models on the model database

As non-limiting examples, this user data regarding each learner may include data derived from, for example, problems within homework, assessments, and/or other assignments. In some aspects, this data may include content from a previous assignment or assessment submitted by the learner. In some aspects, this data may include identification of problems or questions for which the learner has requested help, possibly associated in database with a current or previous assignment or assessment. In some embodiments, this data may include additional data derived by determining a learner's interactions and/or results associated with one or more learning objectives stored in the database.

The database may include a plurality of learning course data. In some aspects, the learning course data may include one or more learning objectives associated with the learning course data. The learning objectives may be identified and input into the system by users, such as system administrators, course creators, instructors, etc., possibly via user input into a graphical user interface 210 (GUI) stored on one or more client devices.

The database may include a plurality of lesson-specific data. In some aspects, the lesson-specific data 607 may include sets of data respectively corresponding to courses such as textbooks, associated quiz problems, homework problems, etc.

The system for distributing educational content 200 may additionally include one or more AI models. For example, the AI models can include generative AI models, such as large language models (LLMs). In other examples, the AI models can include recurrent neural networks (RNNs), convolutional neural networks (CNNs), transformer models, sequence-to-sequence models, word embeddings, memory networks, graph neural networks or any other suitable artificial intelligence model to process language. In further examples, the artificial intelligence models can be stored in a remote or cloud server, which is communicatively coupled to the system server over the network.

In some aspects of the present disclosure, the content management system 202 in coordination can configure the system components (e.g., generative AI models, which may be stored in the databases) for various functions, including, e.g., initializing a content serving environment; receiving a request corresponding to an activity and lesson content from a supervisor device; presenting a supervisory user with refinement options based on the activity and lesson content; receiving an input responsive to the refinement options; generating, using an AI model, supplementary content based at least in part on the lesson content; displaying the supplementary content to the user. Any of the aforementioned functions may be combined, in any combination, by the system for distributing educational content 200 For example, the system components may be configured to implement one or more of the functions described herein.

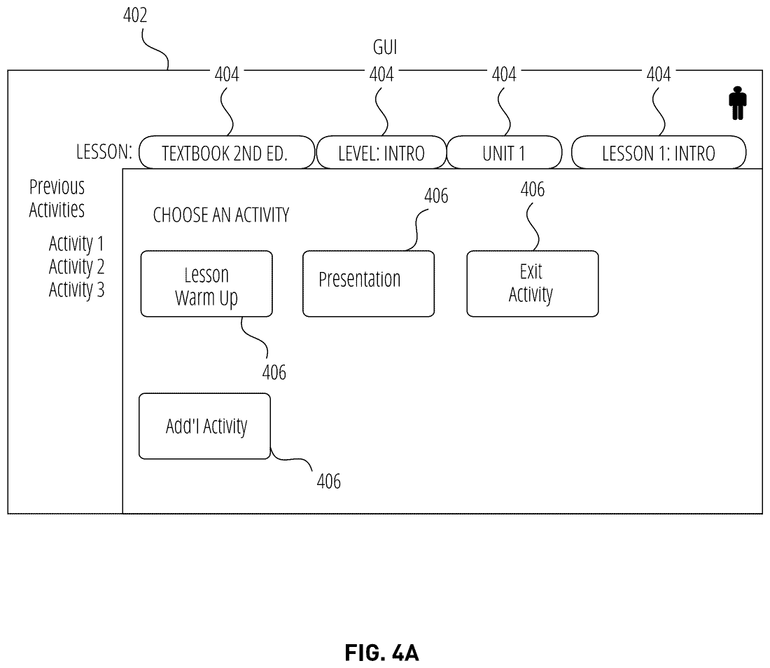

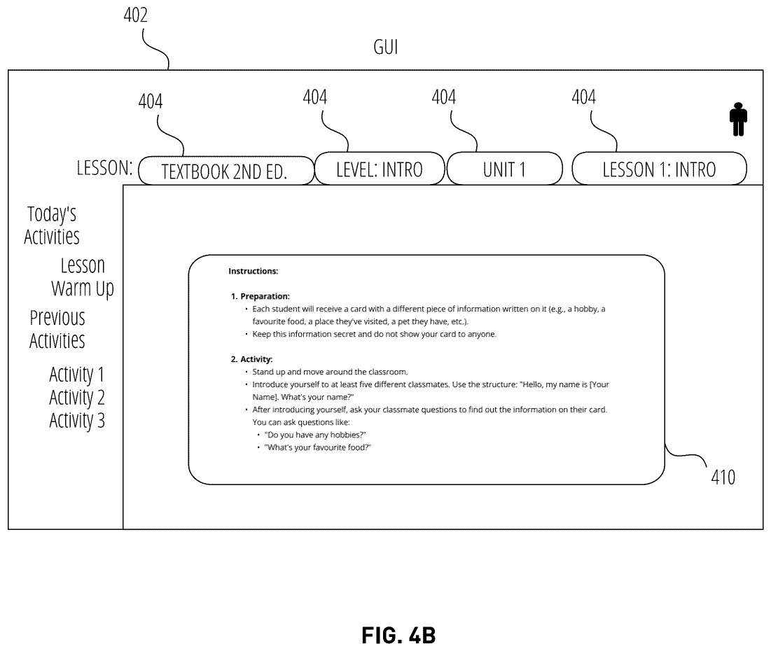

In some examples, the content management system 202 may interact with the client computing device(s) 206 that can be either user devices 106, supervisor device 108, or other computing device, via one or more communication networks 204. In some examples, the client device(s) 206 can include a graphical user interface 210 to render and/or display environments 212 (e.g., dynamic study environments, chatbot windows, etc.) for the user. In some examples, the GUI graphical user interfaces 210 may be generated in part by execution by the client computing device 206 of software 208 based on data received from the system 202 via the network 204. One example of the GUI 210 that may be generated and interacted with is shown and described further below with respect to FIG. 4A and FIG. 4B.

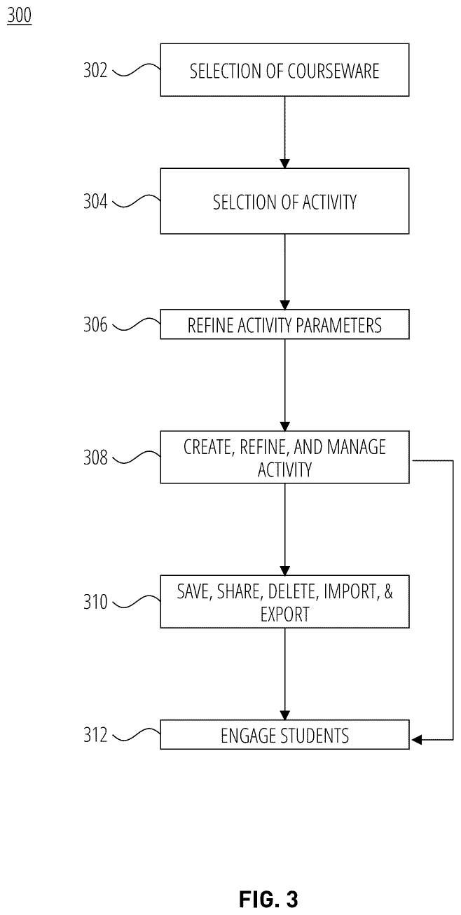

With reference to FIG. 3, a method 300 for using the a system for distributing educational content 200 includes selecting courseware 302. This step can involve, for example, a teacher of a course selecting the textbook used by the teacher and students for the course. Step 302 can also involve additional selections, such as the chapter, subchapter, units, lessons, difficulty level, or other selections in the underlying selection of courseware 302. Next, in step 304, an instructional activity is chosen. According to one aspect of the present disclosure, instructional activities can include supplementary content created by an AI agent according to the teachings herein. The available instructional activities can be limited by the selected educational content from step 302. Instructional activities can include but are not limited to: reading comprehension exercises, true or false questions, fill in the gap questions, writing exercises, lesson warm-ups, exit testing, summary presentations, and reading passages. In step 306, the user can refine activity parameters by, for example, selecting the language fluency level of the students, the number of students, student age level, learning objectives (e.g., reading, speaking, writing, etc.), desired duration of activity. In step 308, the activity is generated based on the inputs at steps 302, 304, and 306. The activities provided in step 308 can now be saved, shared with other teachers, or imported or exported into the system for distributing educational content 200 in step 310. The teacher of the course can now share the activity with the students in step 312 by exporting and providing to students in document format such as .pdf or various open source document formats, for example, or directly by projecting on audiovisual equipment in the classroom.

With reference to FIG. 4A, a GUI 402 is shown after an instructor has selected, through several lesson selectors 404 the courseware of a second edition of a particular textbook, presented at an introductory level, and specifically the first lesson of unit 1 of the text. The instructor can choose between several activities by selecting one or more activity selectors 406, including but not limited to a lesson warm up, generate a presentation for lecture, reading comprehension exercises, true or false questions, fill in the gap questions, writing exercises, lesson warm-ups, exit testing, summary presentations, reading passages, or a variety of additional activities.

As shown in FIG. 4B, the instructor has selected the Lesson Warm Up activity, as shown in the menu bar along the left side of the GUI 402. The Lesson Warm Up activity supplementary content 410 is shown in the GUI, including instructions on preparing the class for the learning activity and step-by-step instructions on conducting the activity. Selection of other activities or other activity selectors 406 will result in alternative supplementary content 410 being presented to the supervisory user.

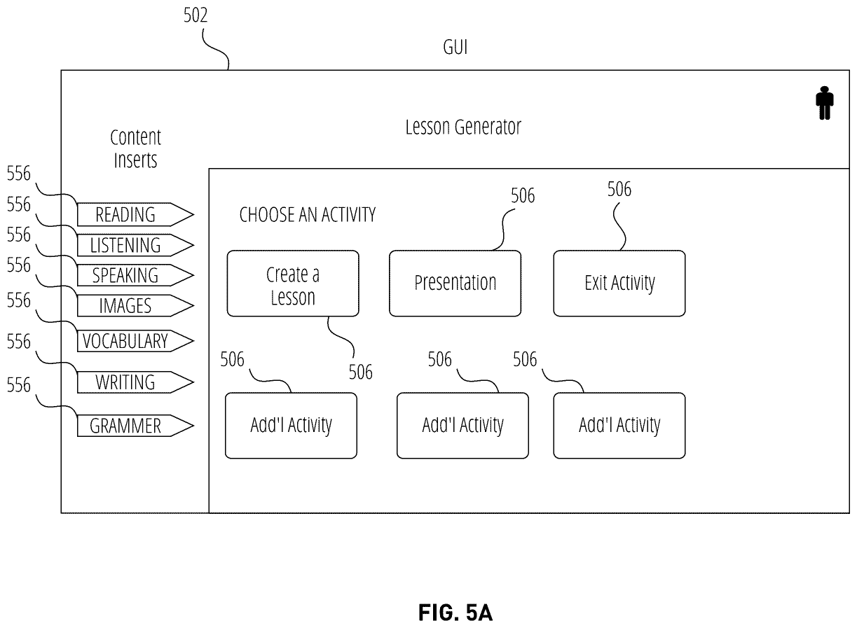

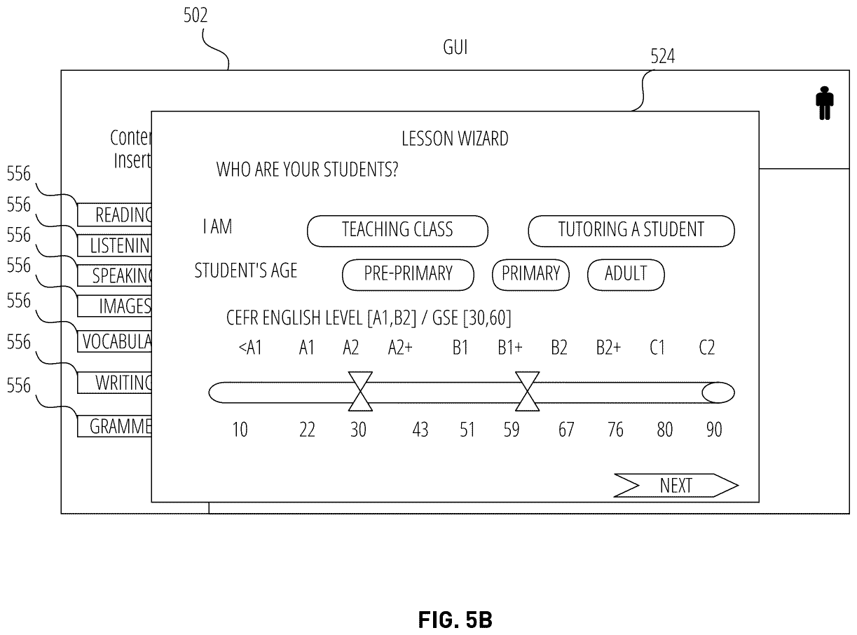

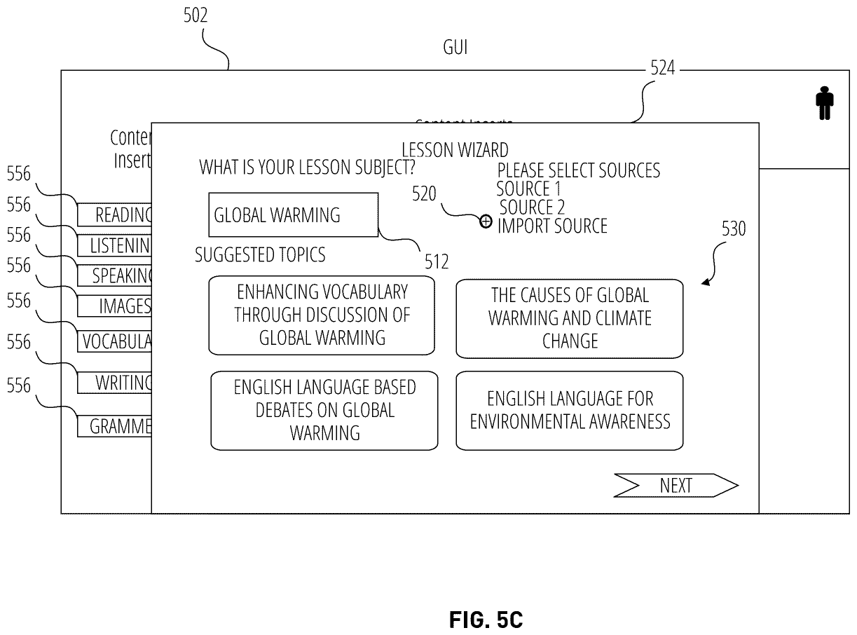

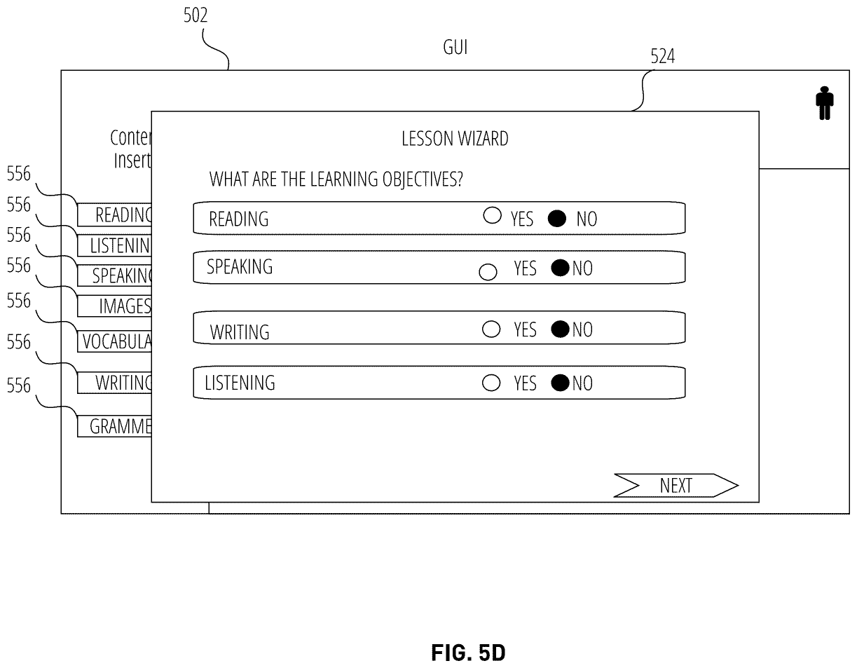

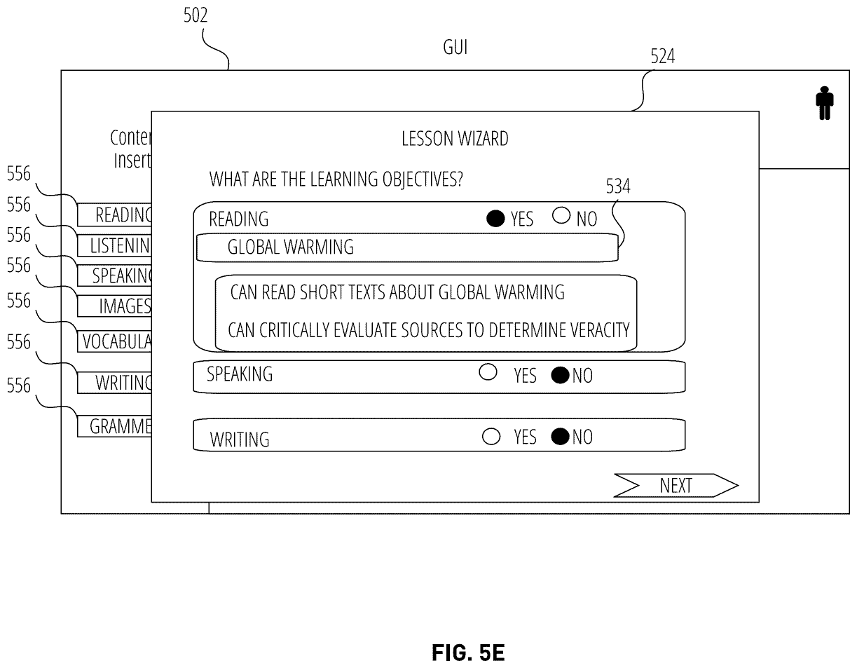

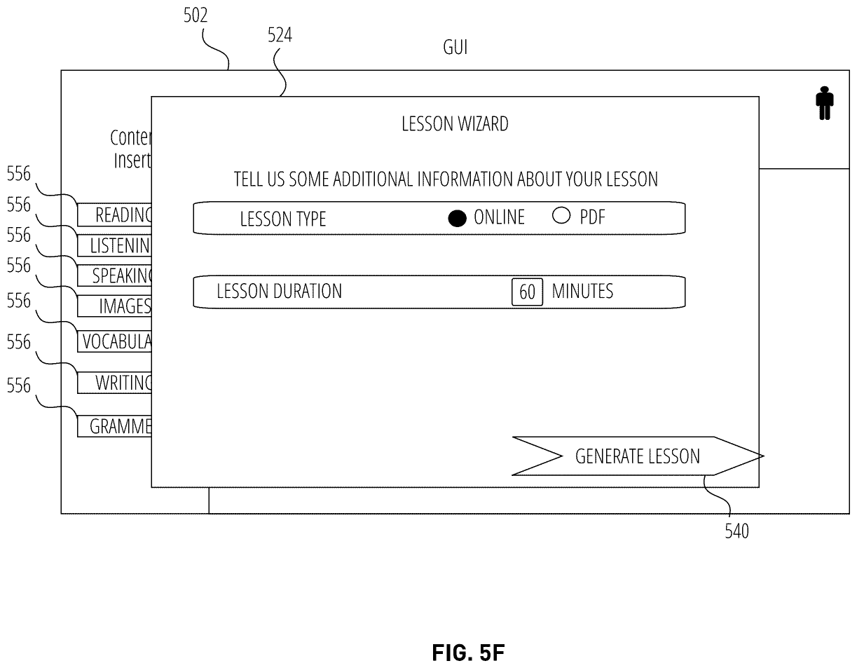

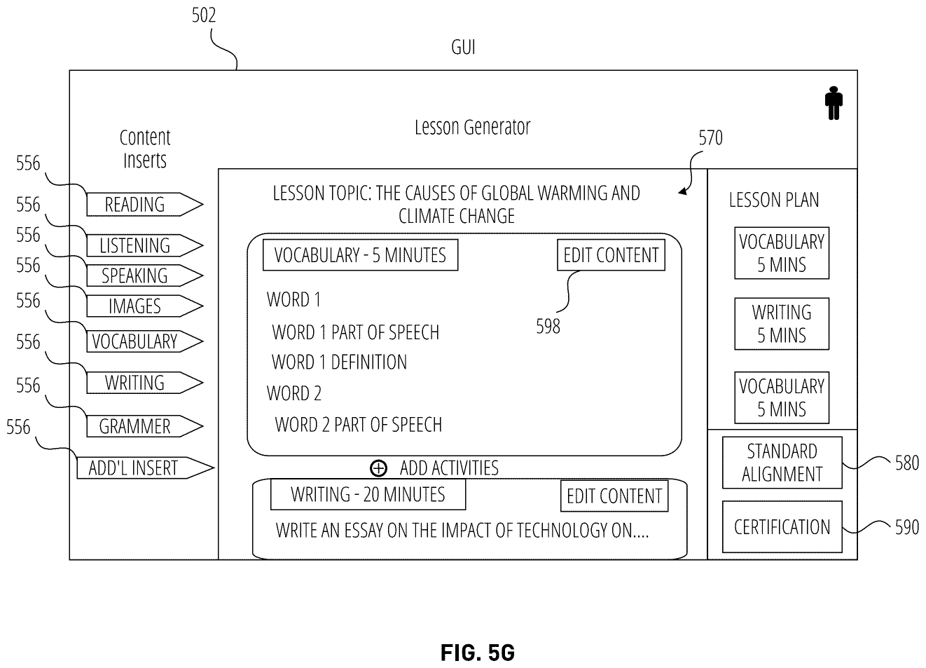

With reference to FIG. 5A, a GUI 502 is shown offering a supervisory user several activities by selecting one or more activity selectors 506 and several, including but not limited to a lesson warm up, generate a presentation for lecture, reading comprehension exercises, true or false questions, fill in the gap questions, writing exercises, lesson warm-ups, exit testing, summary presentations, reading passages, or a variety of additional activities. Selection of one of the activity selectors 506 can open an wizard that can help guide the supervisory user.

With reference to FIG. 5B, once the supervisory user has selected the create a lesson selector 504, the lesson wizard window 524 opens and prompts the supervisory user to input several characteristics about the users, or students, for whom the supervisory user, or teacher, is preparing the lesson. In particular the lesson wizard window 524 asks whether the teacher is teaching class or tutoring a student. It also prompts whether the students age is pre-primary, primary, or adult level. and it also asks for the Common European Framework of Reference (CEFR) for Languages English level that the teacher would like to present the materials in class or equivalently which range of skill most of their class is comfortable with.

With reference to FIG. 5C The lesson wizard window now prompts the supervisory user to enter the lesson subject in text entry field 512 and also make a selection of the source courseware 214. For example, in the current instance, the supervisory user can select one or both of pre-loaded courseware 214a Source 1 and Source 2. Supervisory user can also choose to import a source via the import selector 520. By choosing the import selector 520 and importing courseware 214b, the supervisor user can make that courseware 214b available for the content management system 202 to incorporate the content and information in that imported courseware 214b into the lesson. With further reference to FIG. 5C, the supervisory user's entry of text starting with “Global Warming” has prompted the content management system 202 to offer several suggested lesson topics 530. The supervisory user can select one or more of the suggested topics 530 or maintain the supervisory user's stated lesson subject.

With reference to FIG. 5D, the lesson wizard window 524 then prompts the supervisor user to make a selection of the various learning objectives, some of which can be reading, speaking, writing and listening objectives. By selecting one or more of the radio button shown in FIG. 5D, the supervising user can populate lesson content with the specified objectives.

With reference to FIG. 5E, once the radio button for the reading learning objective is selected, a text entry field 534 drops down soliciting the supervisory user's reading objective. Upon entering “Global Warming” the content management system 202 populates suggestions for learning objectives for the reading learning objective.

With reference to FIG. 5F, the content management system 202 requests information on the lesson type, which can be use online and for example exported to a file supported by a school's learning management software. Alternatively, the lesson can be exported to portable document formats, or other document formats, for example. Once the intended duration of the lesson is input by the supervisory user, the supervisory user can select the generate lesson button 540 and proceed to generate a lesson.

With reference to FIG. 5G, as a result of the supervisory user's inputs into the lesson wizard window 524, the content management system 202 has provided primary supplementary content 570 and also a variety of content inserts 556. The content inserts 556 allow for the supervisory user to add additional materials to the primary supplementary content 570. For example by selecting the. Reading content inserts the supervisory user can add additional reading based activities, questions, and otherwise add content related to the particular selected content insert 556. Likewise for the listening, speaking, vocabulary, visual and other content inserts 556 illustrated in FIG. 5G. The supervisory user can request a report by selecting input 580, which will result in the content management system 202 providing a mapping of the completed lesson to various educational standards, such as the College and Career Readiness Standards (CCRS), World-Class Instructional Design and Assessment (WIDA), or Programme for International Student Assessment (PISA). The content management system 202 can use the AI Server 120 to map any particular lesson created by the supervisory use to a provided teaching standard. Upon completion of creation and use of the lesson in the context of a class environment, the supervisory user can also select input 590 which will output a certification for the respective lesson, for example a Credly badge issued by Pearson.

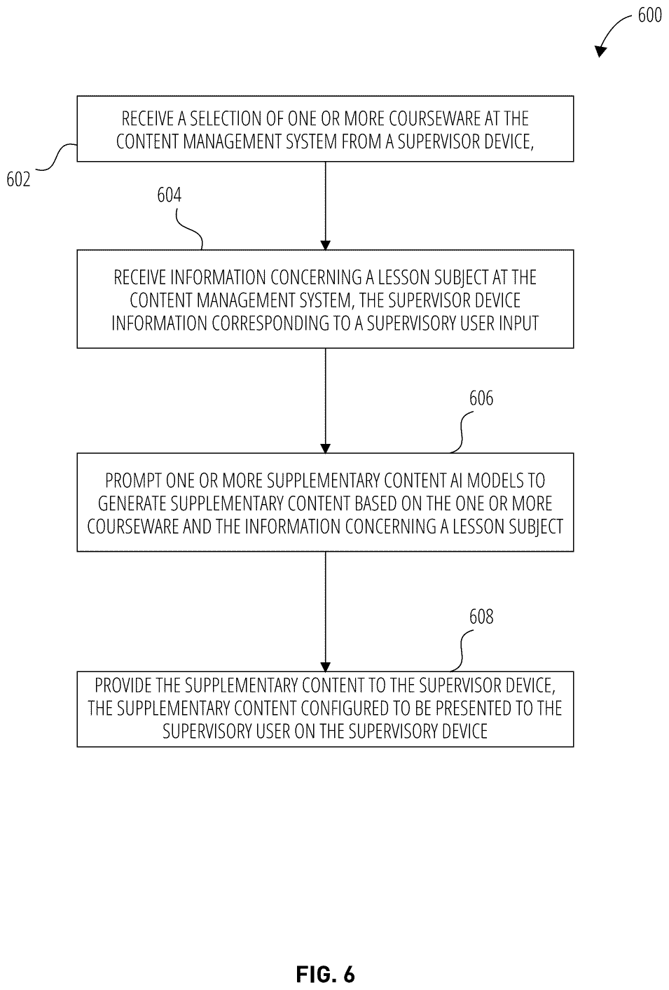

With reference now to FIG. 6, a routine 600 according to the present teachings. In block 602, routine 600 receives at a content management system 202, from a supervisor device 108, a selection of one or more courseware 214. In block 604, routine 600 receives at the content management system 202, from the supervisor device 108, information concerning a lesson subject, and from the supervisor device 108 information corresponding to a supervisory user input. In block 606, routine 600 prompts one or more supplementary content AI models to generate supplementary content based on the one or more courseware and the information concerning a lesson subject. In block 608, routine 600 provides the supplementary content to the supervisor device, the supplementary content configured to be presented to the supervisory user on the supervisory device upon receipt at the supervisory device.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

I claim:

1. A method for operating a content distribution system comprising:
receiving at a content management system, from a supervisor device, a selection of one or more courseware;
receiving at the content management system, from the supervisor device, information concerning a lesson subject, the supervisor device information corresponding to a supervisory user input;
prompting one or more supplementary content AI models to generate supplementary content based on the one or more courseware and the information concerning a lesson subject; and,
providing the supplementary content to the supervisor device, the supplementary content configured to be presented to the supervisory user on the supervisory device upon receipt at the supervisory device.

2. The method of claim 1 wherein the step of providing the supplementary content includes providing primary supplementary content and supplementary content inserts.

3. The method of claim 2 wherein the step of providing the supplementary content includes providing primary supplementary content configured to be presented as suggested lesson content by the supervisory device.

4. The method of claim 3 wherein the step of providing the supplementary content inserts includes providing supplementary content inserts configured to be optionally presented as lesson content by the supervisory device upon the supervisory user selecting such supplementary content insert.

5. The method of claim 4 further comprising:
the step of receiving a request from the supervisor device at the content management system for a mapping of the lesson content to one or more instructional standards;
mapping the lesson content to the one or more instructional standards; and,
providing the mappings to the supervisor device.

6. The method of claim 5 wherein the step of mapping lesson content including mapping lesson content to one or more of the CCRS, WIDA, or PISA.

7. The method of claim 6, further including receiving a request from the supervisor device at the content management system for a certification record of the supervisor user's completion of one or more actions related to the creation and delivery of lesson content.

8. The method of claim 1 further comprising:
the step of receiving a request from the supervisor device at the content management system for a mapping of the lesson content to one or more instructional standards;
mapping the lesson content to the one or more instructional standards; and,
providing the mappings to the supervisor device.

9. The method of claim 8 wherein the step of receiving at a content management system a selection of one or more courseware includes receiving at the content management system one of a selection of one or more pre-loaded courseware or an import of one or more courseware by the supervisory user.

10. The method of claim 1 wherein the step of receiving at a content management system a selection of one or more courseware includes receiving at the content management system one of a selection of one or more pre-loaded courseware or an import of one or more courseware by the supervisory user.

11. A content distribution system comprising:
a content management system having a processor and a memory storing instructions that, when executed by the processor, cause the system to:
receive at a content management system, from a supervisor device, a selection of one or more courseware;
receive at the content management system, from the supervisor device, information concerning a lesson subject, the supervisor device information corresponding to a supervisory user input;
prompt one or more supplementary content AI models to generate supplementary content based on the one or more courseware and the information concerning a lesson subject; and,
provide the supplementary content to the supervisor device, the supplementary content configured to be presented to the supervisory user on the supervisory device upon receipt at the supervisory device.

12. The content distribution system of claim 11 wherein the supplementary content includes primary supplementary content and supplementary content inserts.

13. The content distribution system of claim 12 wherein the supplementary content includes primary supplementary content configured to be presented as suggested lesson content by the supervisory device.

14. The content distribution system of claim 13 wherein the supplementary content inserts includes supplementary content inserts configured to be optionally presented as lesson content on the supervisory device upon the supervisory user selecting such supplementary content insert.

15. The content distribution system of claim 14 further comprising:
the memory storing instructions that, when executed by the processor, cause the apparatus to
receive a request from the supervisor device for a mapping of the lesson content to one or more instructional standards;
map the lesson content to the one or more instructional standards; and,
provide the mappings to the supervisor device.

16. The content distribution system of claim 15, wherein the wherein the memory stores instructions that, when executed by the processor, cause the apparatus to provide mapping of lesson content including mapping lesson content to one or more of the CCRS, WIDA, or PISA.

17. The content distribution system of claim 11 further comprising:
the memory storing instructions that, when executed by the processor, cause the apparatus to
receive a request from the supervisor device for a mapping of the lesson content to one or more instructional standards;
map the lesson content to the one or more instructional standards; and,
provide the mappings to the supervisor device.

18. The content distribution system of claim 17, the memory storing further instructions that when executed by the processor cause the system to receive at a selection of one or more courseware including by being configured to receive at least one of a selection of one or more pre-loaded courseware or an import of one or more courseware by the supervisory user.

19. The content distribution system of claim 18, the memory storing further instructions that when executed by the processor cause the system to receive at a selection of one or more courseware including by being configured to receive an import of one or more courseware by the supervisory user.

20. The content distribution system of claim 11 the memory storing further instructions that when executed by the processor cause the system to receive a request from the supervisor device at the content management system for a certification record of the supervisor user's completion of one or more actions related to the creation and delivery of lesson content.

21. A content distribution system for presenting supplementary content based on courseware to a supervisory user comprising:
a processor and memory coupled to the processor;
wherein the processor is configured to:
receive a request corresponding to an activity and the lesson content from a supervisor device;
present the supervisory user with refinement options based on the activity and lesson content;
receive an input responsive to the refinement options;
generating, using an AI model, supplementary content based at least in part on the lesson content;
displaying the supplementary content to the supervisory user.

22. The content distribution network of claim 21 wherein the lesson content includes an ebook.

23. The content distribution network of claim 21 the memory storing further instructions that when executed by the processor cause the system to:
receive a request from a supervisory user regarding creating a student activity based on a selected courseware;
use an AI model to generate the corresponding student activity based on the requested courseware; and
distributing the generated activity to the appropriate student users via the network.
